(19) United States
(12) Patent Application Publication
(10) Pub. No.: US 2004/0199451 A1
(43) Pub. Date: Oct. 7, 2004

(54) Municipal note index future

(75) Inventors: Joseph F. Benning, Summit, NJ (US); Daniel W. Grombacher, Northbrook, IL (US)

Correspondence Address: FOLEY & LARDNER, 321 NORTH CLARK STREET, SUITE 2800, CHICAGO, IL, 60610-4764, US

(73) Assignee: Chicago Board of Trade

(21) Appl. No.: 10/393,308

(22) Filed: Mar. 20, 2003

(51) Int. Cl. G06F 17/60

(52) U.S. Cl. 705/37

(57) ABSTRACT

A municipal note index futures contract in accordance with the principles of the present invention includes a sufficient number of municipal bonds to maintain a broad reflection of the market as a whole. The municipal bonds represent a widely dispersed sampling. The municipal bonds are issued by an issuer who has a minimal credit rating depending on the target sector. The issue price of the bond must have a minimum value at its issuance date and each municipal bond must have a minimal principal size and be apart of a minimal offering size to be eligible for inclusion. The index is revised frequently enough to prevent the index from becoming “stale” while minimizing disruptions. Bonds that have had outsized price moves on settlement date are eliminated.

### FIELD OF THE INVENTION

The present invention relates generally to municipal bond/note indexes and futures contracts based thereon.

### BACKGROUND OF THE INVENTION

A variety of different types of contracts are traded on various commodity exchanges and other markets throughout the world. A cash contract is a sales agreement for either immediate or deferred delivery of the actual commodity. An option is a contract that conveys the right, but not the obligation, to buy or sell a particular commodity or futures contract on a commodity at a certain price for a limited time. A call option is an option that gives the buyer the right, but not the obligation, to purchase the underlying commodity or futures contract at a certain price (known as the strike price) on or before the expiration date. A put option is an option that gives the option buyer the right, but not the obligation, to sell the underlying commodity or futures contract at the strike price on or before the expiration date.

A futures contract is a legally binding agreement, typically entered into on or pursuant to the rules of a commodity exchange, to buy or sell a commodity (which may be a financial instrument) sometime in the future. A commodity is generally an article of commerce or a product that can be used for commerce. In a narrow sense not intended for use herein, futures and options contracts for commodities are products traded on a formally organized commodity exchange. Unlike cash commercial contracts, futures contracts very rarely result in delivery, because most are liquidated by offsetting positions prior to expiration. The types of commodities commonly include: agricultural products such as corn, soybeans and wheat; precious metals such as gold; fuels such as petroleum; foreign currencies such as the Euro; financial instruments such as U.S. Treasury securities; financial indexes such as the Standard & Poor's 500 stock index; and bond indexes, to name a few.

Municipal Bonds are securities issued by state and local governments and special districts and counties. The funds raised from these bond offerings are typically used to fund improvements and development within the municipality. Investors in the municipal bond market sometimes invest for the altruistic reason of funding local projects. The majority of people investing in the municipal bond market do so because municipal bonds are usually exempt from federal and state taxation.

Municipal finance has become much more sophisticated in recent years. New types of tax-exempt instruments allow issuers to raise funds for needed projects. In 2001 municipal issuance increased to $342.8 billion in long- and short-term bonds, and in 2002 municipal issuance exploded to a $430.7 billion. Today, more than 4.5 million investors hold approximately $1.8 trillion in outstanding municipal bonds, with more than $11 billion likely to change hands on a typical trading day. Advances in technology have enhanced all aspects of trading and price discovery, in both the cash and futures markets. While the municipal marketplace has evolved, the need for effective risk management vehicles grows stronger.

Prior to 1985, participants in the municipal bond market suffered from a lack of hedging vehicles. Because municipal bonds do not typically track Treasury prices closely, Treasury futures are not generally considered to be the most effective hedge against municipal market risk. Factors such as tax law changes and credit risk influence municipal bond yields, while Treasury bond yields are only indirectly influenced by these factors. Moreover, Treasury bonds are subject to international finance developments that have little bearing on local public finance. Also, rules regarding the taxability of accrued interest on municipal bonds in securities lending transactions essentially preclude short sales of municipal bonds, thereby eliminating another possible hedging vehicle. In response to this identified need, in 1985 the Board of Trade of the City of Chicago, 141 West Jackson Boulevard, Chicago, Ill. 60604-2994 (CBOT) introduced a municipal bond futures contract.

The CBOT municipal futures contract of the prior art was based on the Bond Buyer 40 Index (BBI-40), which was specifically developed for the CBOT's municipal futures contract. The Bond Buyer 40 Index is disseminated by Thomson Media, One State Street Plaza, 27th Floor, New York, N.Y. 10004. The unit of trading for the CBOT BBI-40 municipal bond futures contract is $1,000 times the BBI-40 Index. The price basis is points ($1,000) and 32nds of a point. The minimum tick size is 1/32 ($31.25 per contract). The contract is cash settled against the closing value of the BBI-40 Index on the last day of trading. The last day of trading is the seventh business day preceding the last business day of the delivery month. The contracts have quarterly futures expirations (March, June, September, December) with monthly and quarterly options.

The BBI-40 Index is composed of 40 long-term, high-quality, tax-exempt general obligation and revenue bonds. Bond issues are added to and deleted from the BBI-40 Index based on a specified set of criteria. Bonds in the BBI-40 Index must: be rated A− or better by Standard & Poor's or A3 or better by Moody's; have issue size greater than or equal to $50 million (except for housing bonds which require a minimum issue size of $75 million); have a remaining maturity of at least 19 years upon index inclusion; be callable or noncallable; if callable, have the first call date between 7 and 16 years upon index inclusion; pay a fixed, semi-annual coupon; and be reoffered, out of syndicate, and available for inter-dealer trading with prices ranging from 85 to 105 one full day before index inclusion. Standard & Poor's ratings are issued by Standard & Poor's, 55 Water Street, New York, NY 10041 (“S&P”). Moody's ratings are issued by Moody's Investors Service, Inc., 99 Church Street, New York, N.Y. 10007 (“Moody's”).

In addition, the bonds cannot be private placements. Bonds with unusual or extraordinary redemption features may be excluded from the BBI-40 Index at the discretion of The Bond Buyer. Bonds included in the BBI-40 Index must be reoffered and eligible for dealer to dealer trading at least one day prior to inclusion in the BBI-40 Index. No more than three bonds of the same issuer can be included in the BBI-40 Index. If three term bonds from the same issuer are included in the BBI-40 Index, at least one of these bonds must be insured by either Ambac Indemnity Corporation, One State Street Plaza, New York, N.Y. 10004; Financial Guaranty Insurance Company, a GE Capital Company, 125 Park Avenue, New York, NY 10017; Financial Security Assurance Holdings Ltd., 350 Park Avenue, New York, N.Y. 10022; or MBIA Inc., 113 King Street, Armonk, N.Y. 10504.

If more than three term bonds from the same issuer are available for inclusion in the BBI-40 Index, the three largest term bonds in terms of principal value are added. If three or more term bonds are the same size, the term bonds with the longest maturity are added to the BBI-40 Index. A bond is considered issued by the same issuer if such bond has the same nominal and generic security, that is, the same ultimate source of payment for debt service, of another bond in the BBI-40 Index. A first or second lien bond of the same generic security is defined as having been issued by the same issuer.

The BBI-40 Index is priced twice daily at 12 noon and 3 p.m. eastern time by five brokers. Prices submitted are bid, transaction, or an evaluation of the bid side price. Acting as independent brokers, these firms may not take positions in the cash or futures markets. The highest and lowest prices submitted by the brokers for each bond are dropped. The average of the remaining three prices is then divided by a conversion factor that equates the bond's price to a six percent (6%) yield (from 1985 to 1999, the bonds were equated to an eight percent (8%) yield). The 40 converted component bond price numbers resulting from these calculations are then averaged and multiplied by a continuity coefficient. The purpose of this coefficient is to ensure pricing continuity so that the value of the BBI-40 Index does not change as a result of the change in the composition of the bonds included in the BBI-40 Index.

Municipal bond futures contracts are considered by many market participants to be the most important shorting vehicle available to the long end of the municipal market. Market participants have long recognized the value of this contract in the marketplace. The fact that the contract has been available since 1985 is a testimony to its usefulness. However, despite the positive benefits of the contract, it is not widely used in today's marketplace, i.e., there is limited activity involving investors and underwriters. Much of the trading that does occur derives from the activities of arbitrageurs, as well as speculators who trade the municipals over bond (MOB) spread. By taking positions in municipal and Treasury bond futures, participants can trade on their expectations regarding tax-exempt municipal bond yields versus Treasury yields. However, the Treasury Department's 31 Oct. 2001 announcement suspending issuance of 30-year Treasury bonds has eroded the relationship between the municipal bond futures contract and the 30-year Treasury bond futures contracts.

A central problem in municipal bond futures contracts is that there is no “true” measure of “the market.” Creating a suitable operational measure of the municipal bond market requires a trade-off between the diversity of issuance and the reliability of available price data. Unlike the market for U.S. Treasury securities, for example, the tax-exempt bond market is marked by heterogeneity. There are well over one million individual issues outstanding. The entire credit spectrum is represented. The market is geographically fragmented. Issue size ranges from low thousands to hundreds of millions of dollars in par value. In addition, the market is vulnerable to changes in state, local, and federal tax regimes.

The low trading volumes of municipal bond futures contracts has given rise to the ability of a single party to unduly influence the pricing of the contract. In response to this concern, on 16 Dec. 1999 the CBOT received approval from the Commodity Futures Trading Commission (CFTC) to limit the positions that anyone can hold in municipal bond index futures and options to 4,000 contracts during the last three days before the contract expires. The CFTC is an independent agency of the United States government created to administer the Commodity Exchange Act and which is located at Three Lafayette Centre, 1155 21^{st} Street, NW, Washington D.C. 20581. While helping to address single party influence, these limits reduced participation in trading by market participants and reduced liquidity of the market.

Another drawback to municipal bond futures contracts of the prior art is in the pricing discovery of the index. The BBI-40 often traded as a “when issued” index since 60 percent or more of the bonds would fall out of the basket during the three months up to contract expiry. The market had a difficult time of pricing forward since most of the bonds would roll out of the index prior to expiry.

Another drawback to municipal bond futures contracts of the prior art is in the pricing methodology of the index used in the derivation of the municipal futures contract price—throughout the life of the contract, and particularly on index revision and settlement days. The prior art index suffers from the drawback that the index is based on indicative price evaluations, and thus does not necessarily reflect actual transactions or firm quotes. Often, there will be limited float in a particular bond, so no bonds are readily available for purchase or sale. Nonetheless, the index price may move despite the fact that the actual market price for the bond did not.

Another drawback to municipal bond futures contracts of the prior art is that market participants did not have confidence in the price at which they could execute block trades. This decreased liquidity in the municipal futures contract and in the long-term cash market. In response to this concern, in May 2000 the CBOT received approval from the CFTC to allow all-or-none (AON) trades in two-year Treasury note futures and municipal bond futures. Basically, AON trading provides customers with a modified block trading facility in a floor-based environment. In an AON trade, a broker receives an all-or-none order or request for a quote, and notifies the pit of the order and desired quantity. The bid/offer is either accepted or rejected by the broker executing the AON order. The entire quantity of the AON order must be accepted and traded at one price opposite a single party. However, this trade facility has been used infrequently, if at all.

What would therefore be useful would be a municipal note futures contract that allows dealers, mutual funds, money managers, issuers and the like to manage the risks associated with buying, selling, or holding municipal securities. A municipal note futures contract should be useful to institutional investors to expand or reduce exposure of a portfolio of tax exempt securities. A municipal note futures contract should be useful to dealers who are exposed to potential losses on the sale of bonds if interest rates rise by allowing hedging to protect inventory in volatile interest rate environments. A municipal note futures contract should create coverage in anticipation of a more permanent shift into the tax-exempt sector. A municipal note futures contract should enable investors who lack a presence in the tax-exempt market to generate synthetic positions. A municipal note futures contract should maintain a broad reflection of the tax-exempt market as a whole. A municipal note futures contract should utilize a broad-based index, a transparent pricing mechanism, and incorporate accurate settlement pricing.

### SUMMARY OF THE INVENTION

A municipal note index futures contract in accordance with the principles of the present invention allows dealers, mutual funds, money managers, issuers and the like to manage the risks associated with buying, selling, or holding municipal securities. A municipal note index futures contract in accordance with the principles of the present invention enables institutional investors to expand or reduce exposure of a portfolio of tax exempt securities. A municipal note index futures contract in accordance with the principles of the present invention enables dealers who are exposed to potential losses on the sale of bonds if interest rates rise to hedge to protect inventory in volatile interest rate environments. A municipal note index futures contract in accordance with the principles of the present invention creates coverage in anticipation of a more permanent shift into the tax-exempt sector. A municipal note index futures contract in accordance with the principles of the present invention enables investors who lack a presence in the tax-exempt market to generate synthetic positions. A municipal note index futures contract in accordance with the principles of the present invention maintains a broad reflection of the tax-exempt market as a whole. A municipal note index futures contract in accordance with the principles of the present invention utilizes a broad-based index, incorporates a transparent pricing mechanism, and incorporates accurate settlement pricing.

A municipal note index futures contract in accordance with the principles of the present invention includes a sufficient number of municipal bonds to maintain a broad reflection of the market as a whole. The municipal bonds represent a widely dispersed sampling. The municipal bonds are issued by an issuer who has a minimal credit rating depending on the target sector. The issue price of the bond must have a minimum value at its issuance date and each municipal bond must have a minimal principal size and be apart of a minimal offering size to be eligible for inclusion. The index is revised frequently enough to prevent the index from becoming “stale” while minimizing disruptions. Bonds that have had outsized price moves on settlement date are eliminated.

### BRIEF DESCRIPTION OF THE DRAWINGS

FIG. 1 shows the number of issues by date for an example index in accordance with the principals of the present invention.

FIG. 2 is a frequency distribution of coupons in the example index in accordance with the principals of the present invention.

FIG. 3 shows the returns on Treasury securities and the returns implied by quotes on municipal securities of approximately the same duration. FIG. 4 shows the 2001 closing average yields for the example index in accordance with the principals of the present invention.

FIG. 5 shows four histograms which provide a graphical illustration of the distribution shifts within an example contract in accordance with the principals of the present invention on 4 days across 4 weeks in July 2001.

FIG. 6 shows the example contract in accordance with the principals of the present invention nearby quarterly series (index value changes in dollars) from 1 Nov. 2000-25 Oct. 2002.

FIGS. 7 and 8 illustrate the average yield-to-worst and index values, respectively, of the issues in the example contract in accordance with the principals of the present invention.

FIG. 9 shows the example contract in accordance with the principals of the present invention vs. the Bond Buyer 40 Index (Index Values in Decimals) for Nov. 1, 2000-Oct. 8, 2002.

FIG. 10 shows the example contract in accordance with the principals of the present invention vs. the Bond Buyer 40 Index (Modified Duration) for Nov. 1, 2000-Oct. 8, 2002.

FIG. 11 shows the example contract in accordance with the principals of the present invention vs. the Bond Buyer 40 Index (DV01s in Dollars) for Nov. 1, 2000-Oct. 8, 2002.

FIG. 12 illustrates the duration history of the example contract in accordance with the principals of the present invention.

FIG. 13 plots the DV01s of the example contract in accordance with the principals of the present invention that traders would have used to structure such MUT spread positions.

FIG. 14 shows the example contract in accordance with the principals of the present invention vs. a 10-year U.S. Treasury Note Futures (MUT Spread) for Nov. 1, 2000-Oct. 8, 2002.

FIG. 15 shows the example contract in accordance with the principals of the present invention vs. a 5-year U.S. Treasury Note Futures (MUF Spread) for Nov. 1, 2000-Oct. 8, 2002.

FIG. 16 shows the example contract in accordance with the principals of the present invention vs. an U.S. Treasury Bond Futures (MOB Spread) for Nov. 1, 2000-Oct. 8, 2002.

FIG. 17 shows the example contract in accordance with the principals of the present invention vs. an U.S. Municipal Futures (SAM Spread) for Nov. 1, 2000-Oct. 8, 2002.

FIG. 18 shows the example contract in accordance with the principals of the present invention vs. an U.S. Treasury Bond Futures (MOB Spread) for Nov. 1, 2000-Oct. 8, 2002.

### DETAILED DESCRIPTION OF THE INVENTION

The present invention provides for a municipal note index futures contract. Such municipal note index futures contracts in accordance with the principals of the present invention present market users with an investment management tool that accurately reflects the diverse and dynamic marketplace and captures the reality of what portfolio managers currently hold. Thus, municipal note index futures contracts of the present invention promise to serve the needs of hedgers and of those institutional investors seeking temporary exposure to this market sector.

Municipal note futures contract of the present invention correlate closely with portfolios of tax-exempt securities, offering targeted and effective hedges. Thus, the municipal note futures contract of the present invention significantly reduces the challenge of achieving prudent risk management while maintaining compliance with the accounting requirements of Statement of Financial Accounting Standards 133 (“FAS 133”) promulgated by the Financial Accounting Standards Board, 401 Merritt 7, P.O. Box 5116, Norwalk, Conn. 06856-5116.

Municipal note futures contract of the present invention offer market users price transparency. The underlying municipal note index of the present invention is structured such that the value of the index and the prices and yields of its component bonds are easily accessible. For example, this data is published daily on the CBOT website located at www.cbot.com. This provides information on how the value of the index and the futures contract of the present invention are derived. In addition, open auction and screen-based trading platforms of futures markets provide means for market users with differing information and outlooks to discover the market-clearing price of the moment. These markets then make these prices publicly available for all to see. The price transparency of municipal note index futures of the present invention speeds the time and lowers the costs of transactions associated with managing the risks inherent in a portfolio of tax-exempt securities.

The municipal note futures contract of the present invention promotes progress toward standardization of an underlying market that currently lacks a widely accepted and easily referenced benchmark. Standardization will, in turn, make it easier for market users to manage tax-exempt portfolio exposure and to evaluate the relative utility and effectiveness of alternative positions and strategies.

Futures users often encounter significantly lower administrative costs than do users of cash market or over-the-counter (OTC) alternatives. For example, the use of futures eliminates the administrative costs and liabilities associated with maintenance of cash market and OTC cash flows. Further, the use of municipal note index futures of the present invention avoids the manpower and financial search and record keeping costs that alternative modes of risk management entail.

The municipal note index futures contract in accordance with the principles of the present invention derives from an underlying index of securities. The municipal note index of the present invention is the underlying cash instrument of the municipal note futures contract of the present invention. The municipal note index of the present invention is composed of municipal bonds that are generally exempt from federal income taxation.

The number of municipal bonds in the municipal note index of the present invention should be sufficient to maintain a broad reflection of the tax-exempt market as a whole. In a preferred embodiment, the municipal note index of the present invention is comprised of 100 to 250 municipal bonds that are generally exempt from federal income taxation. This may include generally exempt bonds whose interest payments may be subject to an alternative minimum tax.

Bonds included in the index are issues that meet certain criteria. For a security to be eligible for inclusion in the index of the present invention, the issuer has a minimal credit rating depending on the target sector. For the index of the present invention to be a representative sample of market values in the high-grade sector of the tax-exempt bond market, in a preferred embodiment the issuer has an AAA credit rating, as determined by both Standard and Poor's Corporation and Moody's Investors Service. If any bonds in the index suffer a downgrade to below a minimal credit rating during the life of the index, that bond will be eliminated from the index. For the index of the present invention to be a representative sample of market values in the high-grade sector of the tax-exempt bond market, in a preferred embodiment if any bonds in the index suffer a downgrade to a credit rating below A− or A3, it will be eliminated from the index.

A characteristic feature of securities markets is that larger issues have broader, deeper markets with wider participation. All else equal, larger issues are assumed to be more widely held, liquid, tradable, and transparent. Consequently, market prices of larger issues are more likely to represent true value. Thus, to be eligible a bond has minimal principal size and is apart of a minimal offering size. In a preferred embodiment, the bond has a principal size of at least $50 million and is a part of a municipal issue with a total deal size of at least $200 million. This $50 million issue size and $200 million deal size are sufficiently large to find issues with broad ownership without unduly constraining the selection pool.

Further, the structure of the yield curve is such that maturities longer than about 10 Years reflect capital market rates of return as distinct from money market rates. However, perpetual bonds (such as, by analogy, consoles—the cash municipal market doesn't use consoles) would be excluded by the requirement for a fixed maturity date. In a preferred embodiment, the remaining maturity is between 10 and 40 years from the first calendar day of the corresponding futures contract expiration.

Municipal bonds are typically callable. An eligible bond can be callable or non-callable. When bonds are callable, by convention they “trade to the call” when the dollar price is at a premium to the call price. In a preferred embodiment, the bond has a first call date at least 7 years from the first calendar day of the corresponding futures contract expiration. By requiring a call date no less than 7 years, the index of the present invention retains its validity as a capital markets measure.

Municipal bond investors typically seek tax-free income. This income comes from the coupon, not from price accretion, which is taxed at either regular marginal tax-rates or capital gains rates, depending on the holding period. Minimum price parameters serve to keep the Index focused on the present value of expected future coupon income. In a preferred embodiment, the issue price of the bond must be at least 90-00 at its issuance date. Also, having a floor of 90 on issuing price avoids material de minimus issues regarding original issue discounts.

A preference for current coupons incorporates current market levels and call protections into the index. Thus, to be eligible a bond must pay regular interest at a fixed coupon rate within a percentage range. In a preferred embodiment, the bond must pay semi-annual interest at a fixed coupon rate that ranges from three percent (3%) to nine percent (9%).

To maintain a broad reflection of the tax-exempt market as a whole, the bonds represent a widely dispersed sampling. In a preferred embodiment, no more than five percent (5%) of the bonds in the index can be from any one issuer. To maintain transparency, in a preferred embodiment no more than fifteen percent (15%) of the bonds in the index can be from any one state or territory. Further, the bonds in the index may or may not be insured. If the index includes insured bonds, in a preferred embodiment no more than forty percent (40%) of the bonds in the index can be insured by any one issuer. In a preferred embodiment, bonds issued as private placements are not eligible for inclusion in the index.

The composition of the index is revised to ensure that it remains an accurate gauge of the municipal bond market. In revising the index of the present invention, a balance must be struck between keeping the index fresh with new issues and keeping the index representative as a benchmark by including seasoned issues. In a preferred embodiment, the composition of the index is revised quarterly. Less frequent revisions would minimize disruptions, but might allow the index to become “stale.” More frequent revisions might prevent the index from becoming “stale,” but would increase disruptions. It is expected that index turnover will be on the order of 10 to 20 percent of the bonds in the index at each revision. Also, keeping the index fixed through expiration facilitates price discovery as the index is known from its creation through expiration.

To remove both the incentive and means to materially influence the final cash settlement price beyond where it would otherwise fall, the settlement price reduces the likelihood of index distortion due to sudden outsized moves by a small number of bonds. On the last day of trading, any bond whose price change from the previous day is more than one standard deviation above or below the average price change of all the component bonds will be excluded from the index for determination of the settlement price. Because this rule eliminates bonds that have had outsized price moves on settlement date, the final index price is apt to be more representative of the whole of the subject sector of the municipal bond market. This helps ensure the integrity and consistency of the index of the present invention, and thus the reliability of futures contracts in accordance with the present invention.

Using only bonds whose overnight price move is less than or equal to one standard deviation from the mean is meant to embed “strategy-proofness” into the final settlement procedure. In accordance with economic game-theory, strategy-proof rules prevent or impede actors from acting in ways they would have otherwise avoided in order to create a preferred outcome. In this case, the actors cannot unduly determine the final outcome (i.e., the final settlement price), because to the extent that their behavior causes an outsized bond price move, the bond will not be considered for the final settlement calculation. Moreover, the determination of eligibility is ex-post, so strategic behavior is constrained ex-ante. See, for example, Brams, S. J., Theory of Moves. Cambridge, England: Cambridge University Press 1994.

In the event that more than the maximum number bonds meet the eligibility requirements at an index revision time, the issue size standard can be increased until it arrives at a level where no more than the maximum bonds remain eligible for inclusion. Index revisions must not result in violation of any of the eligibility requirements.

Determination of the index value is key to the effective use of the municipal note futures contract of the present invention in risk management and trading strategies. The fair market value calculation of the municipal note index must be efficient, transparent, and provide market users with an effective risk management and trading tool. The index is priced once daily by a single independent evaluation pricing service. In a preferred embodiment, the independent evaluation pricing service is FT Interactive Data. FT Interactive Data is an operating division of Interactive Data Corporation, 22 Crosby Drive, Bedford, Mass. 01730. The independent evaluation pricing service provides evaluated prices for the individual component bonds and computes the closing value of the index. This enhances the fair market value determination of the index, providing a more effective risk management tool.

A municipal note contract of the present invention will cash settle on the last day of trading based on the independent evaluation pricing service determination of the underlying index value. The independent evaluation pricing service calculates the final settlement value (FSV) of the futures contract according to the following:

FSV=$100,000*[5/r+(1−5/r)*(1+r/200)−20];

where r represents the simple average yield-to-worst of the component bonds in the index for the last day of trading, expressed in percent terms and calculated to the nearest 1/10 of a basis point. For example, if the simple average yield-to-worst for the last day of trading is five and one quarter percent, then r is equal to 5.25.

The contract expiration price will be the final settlement value rounded to the nearest one thirty-second of one point. For further example, suppose the simply average yield-to-worst on the last day of trading is 5.50. The final settlement value will be 96.19318. To render this in terms of price points and thirty-seconds of price points, note that it is between 99-7/32nds and 99-6/32nds (where each price point equals $1,000.00):

$$\begin{matrix}99 \text{-} 7 \text{/} 32 nds & = 96.21875 \\ Final Settlement Value & = 96.19318 \\ 99 \text{-} 6 \text{/} 32 nds & = 96.18750\end{matrix}$$

The final settlement value is nearer to 99-6/32nds. Thus, the contract expiration price is obtained by rounding down to 99-6/32nds. In the event that the final settlement value is at the exact midpoint between any two adjacent thirty-seconds of a price point, the contract expiration price will be obtained by rounding up to the nearest thirty-second of a point. On the last day of trading, open contracts will be marked to market based on the closing futures prices. A final mark to market will be made on the day the contract expiration price is determined.

Set forth below are examples of an index and futures contract in accordance with the principles of the present invention. While various particulars are used in the following examples in order to portray the principles of the present invention, the present invention is not limited to such. Thus, the following are non-limiting illustrative examples of financial products in accordance with the principles of the present invention

### Example Municipal Note Index

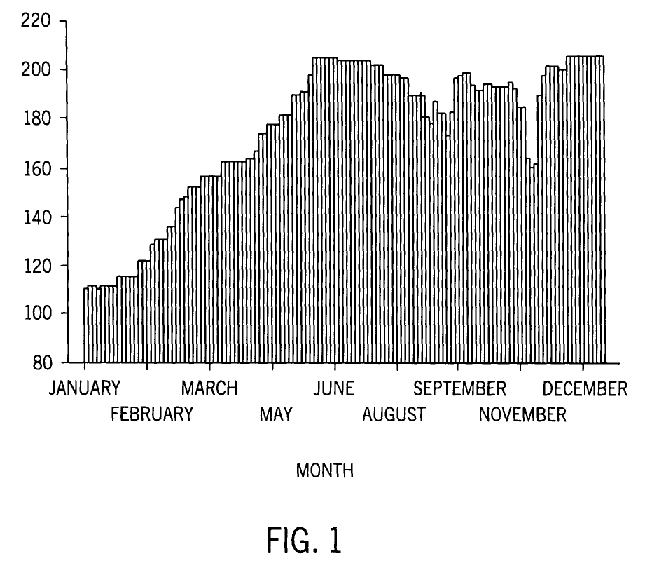

An example municipal note futures index in accordance with the present invention was formed with between 110 and 203 AAA-rated bonds, depending on the time of the year. As more data became available, additional bonds were included in this example index. FIG. 1 shows the number of issues by date for this example index. All bonds in the example index were exempt from federal income taxes. The minimum acceptable issue size was $250 million par value. Coupons ranged between four percent (4%) and six and a quarter percent (6¼%). As of 2001, the bonds had a minimum maturity of 15 years. No bonds were callable before 2010.

Twenty-one states were represented either directly or by a jurisdiction within the state. Sixty-five percent (65%) of the Index (measured by the number of term issues included) is made up of bonds issued by the Commonwealth of Puerto Rico, 6 states (California, Georgia, Massachusetts, Missouri, New Jersey, New York), or political subdivisions or entities falling under their jurisdiction. Table 1 lists additional descriptive statistics for bonds in this example index:

TABLE 1

| | N | Minimum | Maximum | Mean | Std. Dev. | Std. Error |
|---|---|---|---|---|---|---|
| Coupon Rate | 204 | 4.000 | 6.250 | 5.40527 | 2.20E−02 | .31484 |
| ISSUE AMT | 204 | 3.0E+08 | 1.6E+09 | 5.6E+08 | 2.2E+07 | 3.2E+08 |
| Valid N (list wise) | 204 | | | | | |

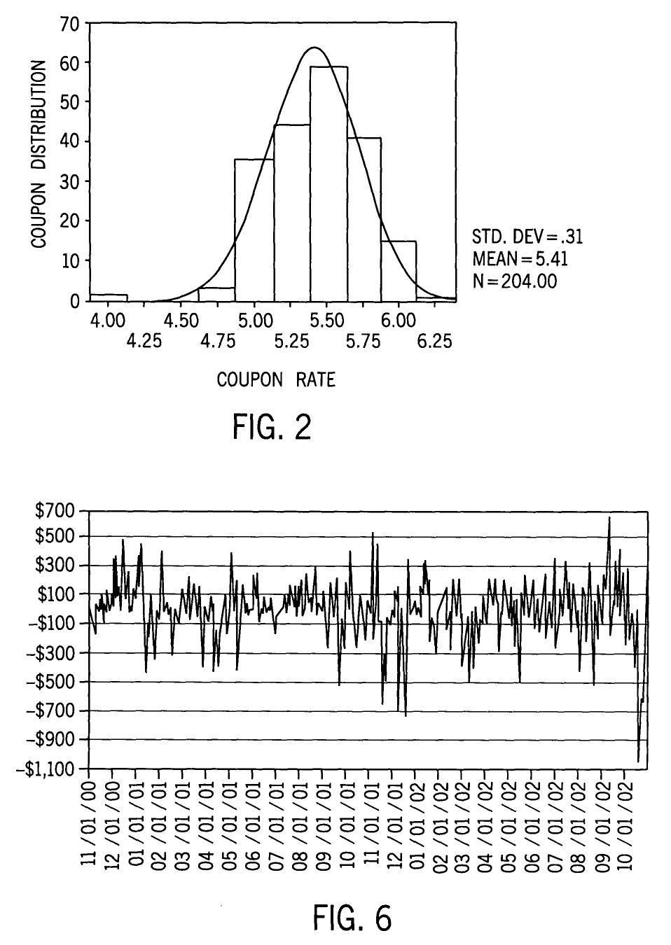

FIG. 2 is a frequency distribution of coupons in this example index.

Statistical analysis was performed on this example index focusing on two areas of inquiry using 2 Jan. 2001 through 19 Dec. 2001 as the sample time frame. The first area of investigation was index sensitivity to the general level of interest rates. The second area of investigation was potential value of the index as a hedging tool both within the tax-exempt sector and across the tax-exempt and taxable sectors (compared to the available alternatives). For testing, the example index was subject to correlation and regression analysis.

Interest rate, within-sector, and cross-sector index sensitivity were analyzed by comparing the performance of the example index to certain other financial instruments. These financial instruments include constant maturity cash 10-Year Treasury Notes, 10-Year Treasury Futures Contracts, Constant Maturity 30-Year Treasury Bonds, Bond Futures Contracts, and the BBI-40. For evaluating index volatility, tests were conducted on three different specifications of the example index: as a 10-year maturity; as a 15-year maturity, and as a 20-year maturity. For the purposes of these tests, net carry was assumed to be zero.

The first step in evaluating the example index involved correlating the daily returns generated by the contract with typical returns generated both by “the market” and by alternative hedging tools. Daily returns are defined as first differences of the natural logs of daily closing prices. The market measure was an index consisting of 32 national municipal bonds funds. Alternative hedging tools include the BBI-40, 10-Year and 30-Year Treasury Futures Contracts, and 10-Year and 30-Year constant maturity Treasuries. The respective correlation coefficients of the various instruments are illustrated in Table 2:

TABLE 2

| Cash | CASH | 10-YR T-Note | Bond Futures | | Example |
|---|---|---|---|---|---|
| 10-YR | 30-YR | Contracts | Contracts | BBI-40 | Index |
| 0.676 | 0.661 | 0.608 | 0.604 | 0.832 | 0.943 |

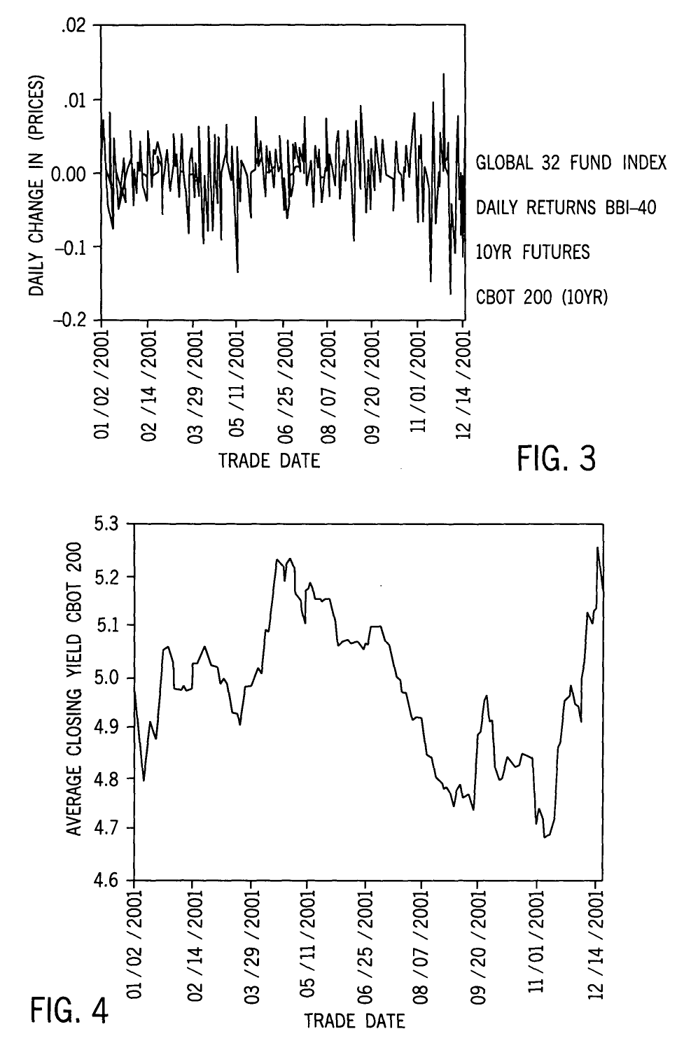

Of all the instruments tested, by far the example index most closely correlated with the market. In addition, the fact that both the BBI-40 and the example index have relatively low correlation with similar duration Treasury securities (and derivations of them) indicates that substantial relative price risk lies outside general movements in market interest rates. FIG. 3 illustrates the reason why: the returns on Treasury securities are more volatile than the returns implied by quotes on municipal securities of approximately the same duration. This, in turn, implies that yield spreads between Treasury and municipal securities of equal duration can be fairly volatile. Because Treasuries are the risk-free rate benchmark, Treasury-Municipal spread volatility suggests that other variables need to be considered in devising a hedging tool.

In addition to correlation analysis, the returns of the example index can be regressed against the returns generated by the 32 Fund Municipal index, using different specifications for the example index to test the effects of duration change on volatility with respect to the 32 Fund Municipal index. The results of those regression estimates are summarized in Table 3:

TABLE 3

| X_{a...e} | Adj. R² | alpha | Beta | N |
|---|---|---|---|---|
| CBOT 10 YR | 0.888 | −2.64E−05 | 0.926 | 239 |
| CBOT 15 YR | 0.888 | −2.65E−05 | 0.689 | 239 |
| CBOT 20 YR | 0.888 | −2.65E−05 | 0.574 | 239 |
| BBI-40 | 0.692 | −4.88E−05 | 0.542 | 236 |
| 10 TR T-Note | 0.37 | −8.20E−05 | 0.238 | 233 |
| Futures | | | | |

The respective Betas of these instruments provide measures of their respective volatility with respect to the overall performance of the high-grade tax-exempt bond market (using the mutual fund index as a proxy measure). As Table 3 makes clear, the example index with a 10-Year maturity structure provides the closest imitation of the high-grade market.

While the example index with a 10-Year maturity provides the closest replication of the market, the Beta coefficient is not necessarily always stable across all market environments. Table 4 below illustrates changes across the 4 delivery periods in 2001:

TABLE 4

| Contract | | | | |
|---|---|---|---|---|
| Period | Adj. R² | alpha | Beta | N |
| March | 0.887 | 7.892E−05 | 0.785 | 54 |
| June | 0.916 | −1.05E−05 | 0.951 | 63 |
| September | 0.856 | −1.53E−06 | 1.095 | 58 |
| December | 0.897 | −1.80E−05 | 0.941 | 64 |

In addition to general market level and cross-sector risk, tax-exempt securities with the same credit ratings pose additional risks for holders. One way to explore this is to compare the distribution of yields over time with the distribution of yields across bonds at a single point in time. Another is to examine changes in the distribution of yields across an unchanging universe of bonds while allowing general market levels to change.

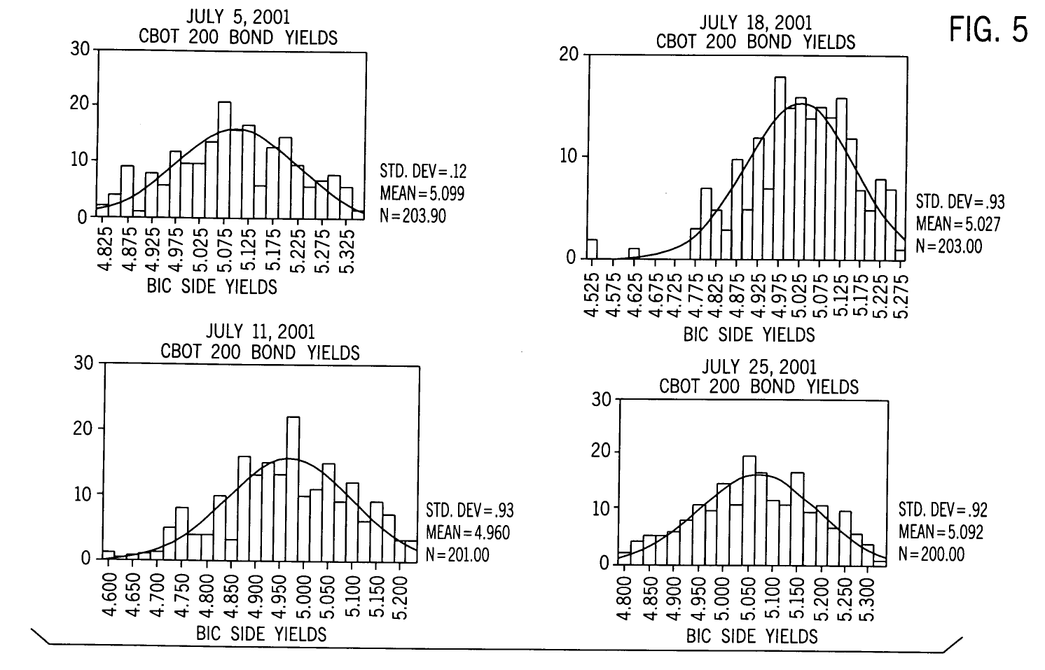

FIG. 4 shows the 2001 closing average yields for the example index. As FIG. 4 illustrates, during the time frame the example index traded between an average yield of approximately 5.20% and 4.70%, a range of about 50 basis points. But yield spreads across index bonds typically ranged over 50 basis points on a single day. The histograms in FIG. 5 provide a graphical illustration of the distribution shifts within the CBOT 200 on 4 days across 4 weeks in July 2001. Moreover, over the entire year, the standard deviation of the mean yield of the example index differentiated by month varied between 0.1264 and 0.1787, indicating that bonds in the example index probably continued to change position relative to each other.

Within-sector shifts in yield distributions can arise from a number of factors, including changes in coupon preference, credit quality, and in state tax regimes. The example index can be used to express preferences for these factors within the “AAA” sector among similar duration issues. For instance, an arbitrageur could establish a duration-weighted short of the example index against a long position in cheap South Carolina paper in anticipation that a temporary overhang in supply will be eliminated as bonds are distribute. Or traders anticipating a tightening of quality spreads might go long “AA” rated bonds against an Index short. Finally, the example index can be traded against swap contracts and Treasury contracts.

Thus, these statistical tests on the example index provide evidence that its correlation with the cash tax-exempt market represents a marked improvement over both the BBI-40 Index and currently available taxable instruments.

### Example Municipal Note

An example March municipal note futures contract of the present invention specifies a $100,000 par trading unit, prices in points ($1,000) and thirty-seconds, has a 1/32 ($31.25) tick size, and trades on the March, June, September, December cycle. The example municipal note futures index of the present invention was formed with 247 AAA-rated bonds from 127 issuers located in 31 states and territories. The average principal amount of the included bonds was over $105 million. Also, these bonds are parts of larger deals with average issue sizes in excess of $569 million. Index revisions will occur on the first business day of each February, May, August, and November. For example, the index revision for the March contract will occur on the first business day in November, five months ahead of the contract expiration.

On these revision days, issues that no longer meet the selection criteria will be dropped from the index. For example, a callable bond that now has less than 7 years to first call will be dropped. Similarly, an issue that has suffered a credit downgrade will be dropped from the index. Note that bonds may fall to AA or A during the life of the index; however, if any security in the index suffers a downgrade to a credit rating below A− or A3, it will be eliminated from the index.

Table 5 summarizes the example March municipal note futures contract:

TABLE 5

| First Calendar Day of Correspondence Contract: | Mar. 01, 2001 | |
|---|---|---|
| Number of Bonds: | 247 | |
| Number of Issuers: | 127 | |
| Number of States: | 31 | |
| Average Dated Date: | Dec. 05, 1998 | |
| Average First Coupon Date: | May 28, 1999 | |
| Average Coupon: | 5.23 | |
| Number of Bonds with Coupon Between 3 Percent and 9 Percent: | 247 | |
| Average Maturity Date: | Jun. 04, 2025 | |
| First Calendar Day of Corresponding Contract Expiration Plus 10 Years: | Mar. 01, 2011 | |
| First Calendar Day of Corresponding Contract Expiration Plus 40 Years: | Mar. 01, 2041 | |
| Number of Bonds with Remaining Maturity Between 10 and 40 Years: | 247 | |
| | # of Bonds | % Share of Index |
| AMBAC Insured: | 38 | 15.4% |
| FGIC Insured: | 70 | 28.3% |
| FSA¹ Insured: | 50 | 20.2% |
| MBIA Insured: | 84 | 34.0% |
| Other Insured/Uninsured: | 5 | 2.0% |

| | |
|---|---|
| Number of Bonds Rated “Triple A”: | 247 |
| Average Principal Amount: | $105,136,538 |
| Number of Bonds with Principal Amount Greater than $50 Million: | 247 |
| Average Issue Amount: | $569,100,325 |
| Number of Bonds with Issue Amount Greater than $20 Million: | 247 |
| Average First Call Date: | Feb. 17, 2009 |
| Average Premium Price: | 101.45 |
| First Calendar Day of Corresponding Contract Expiration Plus 7 Years: | Mar. 01, 2008 |
| Number of Bonds with at least 7 Years to First Call Date: | 247 |
| Average Par Call Date: | Jul. 24, 2010 |
| Number of Callable Bonds: | 219 |

¹The Financial Services Authority, 25 The North Colonnade, Canary Wharf, London E14 5HS

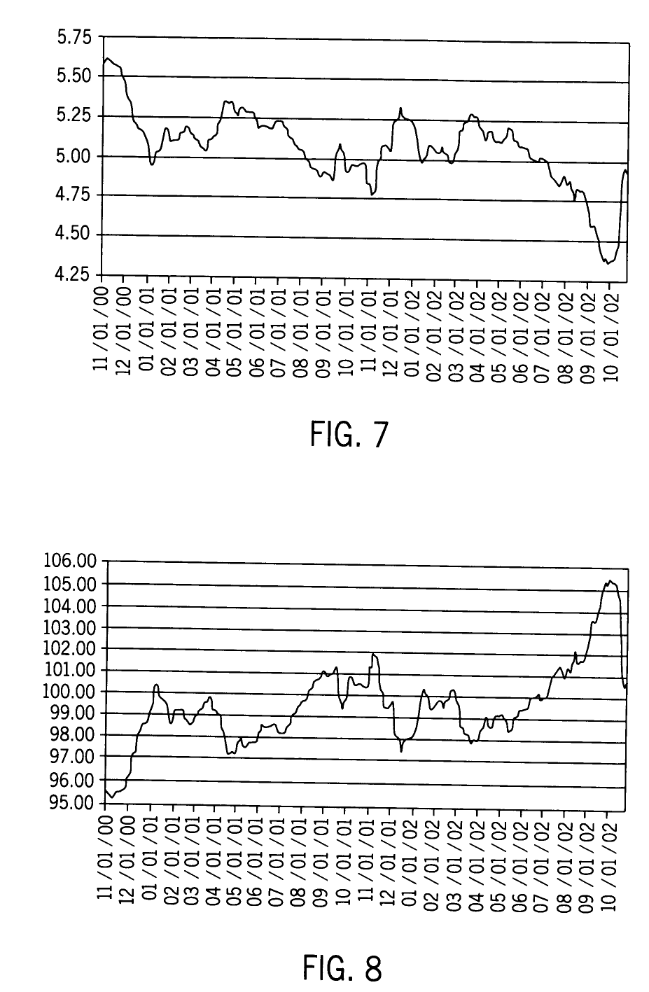

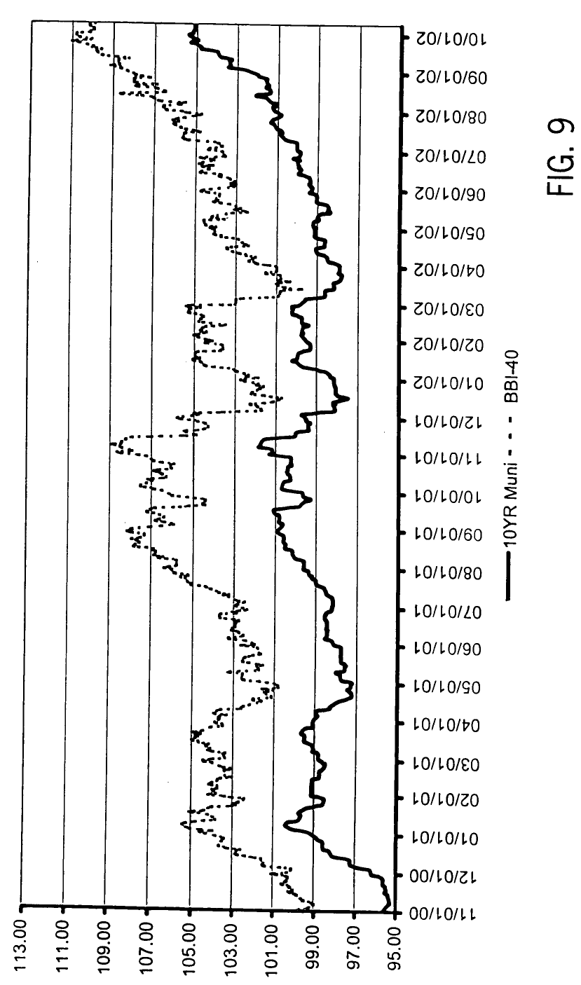

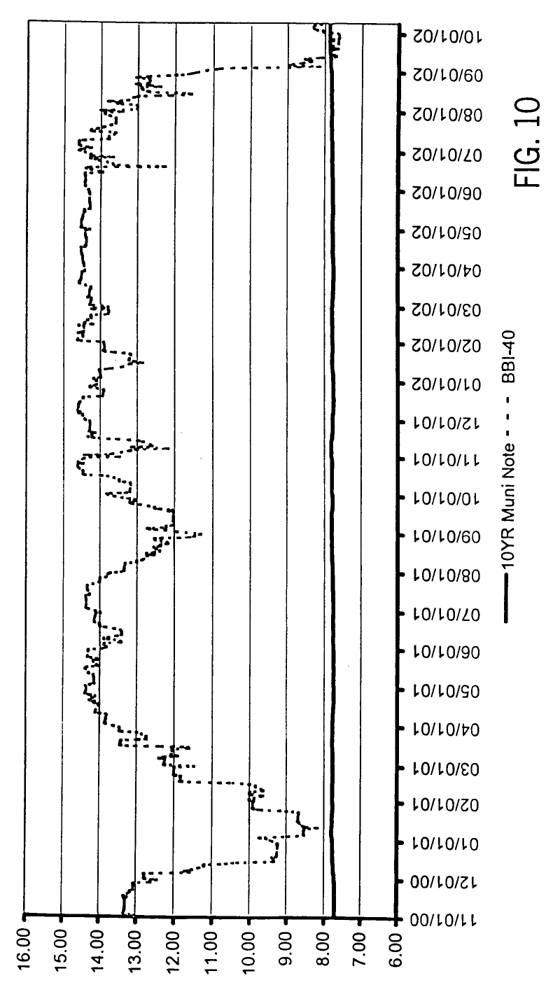

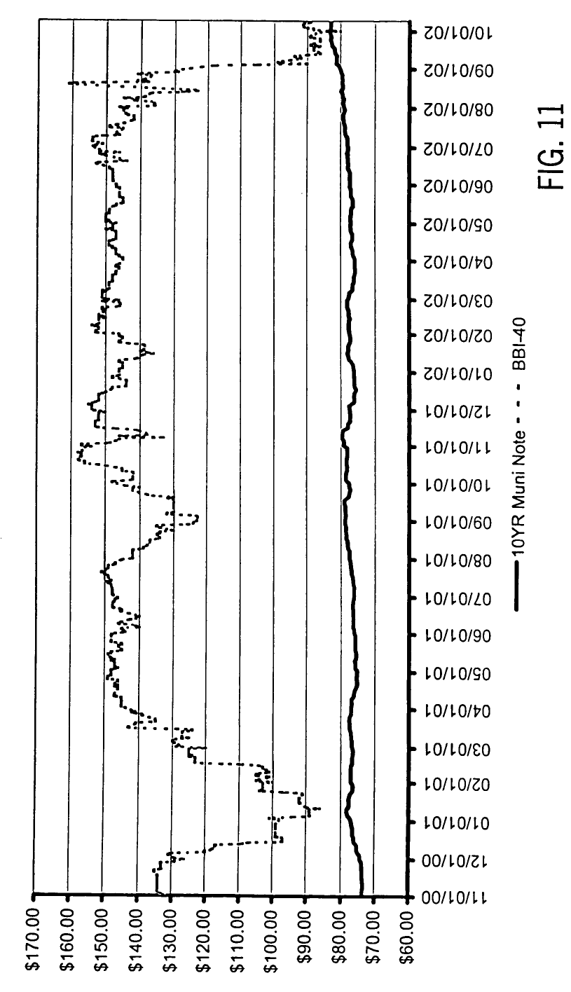

FIG. 6 shows the example municipal note futures contract on a nearby quarterly series basis (index value changes in dollars) from 1 Nov. 2000-25 Oct. 2002. As the plot of index value changes in FIG. 6 illustrates, this portfolio responds to the volatility inherent in this dynamic and competitive marketplace. FIGS. 7 and 8 illustrate the average yield-to-worst and index values, respectively, of the issues in the example index underlying the futures contract. FIG. 9 shows the example municipal note futures contract vs. the Bond Buyer 40 Index (Index Values in Decimals) for Nov. 1, 2000-October 8, 2002. FIG. 10 shows the example municipal note futures contract vs. the Bond Buyer 40 Index (Modified Duration) for Nov. 1, 2000-Oct. 8, 2002. FIG. 11 shows the example municipal note futures contract vs. the Bond Buyer 40 Index (DV01 s in Dollars) for Nov. 1, 2000-Oct. 8, 2002.

### Example of Use of the Present Invention—Hedging Inventory

When holding bonds in inventory, dealers are exposed to potential losses on the sale of those bonds if interest rates rise. Dealers seeking to protect inventory in volatile interest rate environments can use a municipal note contract of the present invention to design effective hedges.

### Example of Use of the Present Invention—Asset Allocation

Institutional investors who already allocate capital to a portfolio of tax exempt securities can use a municipal note contract of the present invention to expand or reduce exposure to this fixed-income sector. This portfolio rebalancing can take the form of tactical asset allocation. Moreover, a municipal note contract of the present invention can create instant coverage in anticipation of a more permanent shift into the tax-exempt sector. Similarly, investors who lack a presence in the tax-exempt exempt market can use municipal note futures contract of the present invention to generate instant synthetic positions. This allows them to shift to holdings in the actual securities when it is more advantageous for them to do so.

### Example of Use of the Present Invention—Cost-Effective Duration Adjustment Tactics

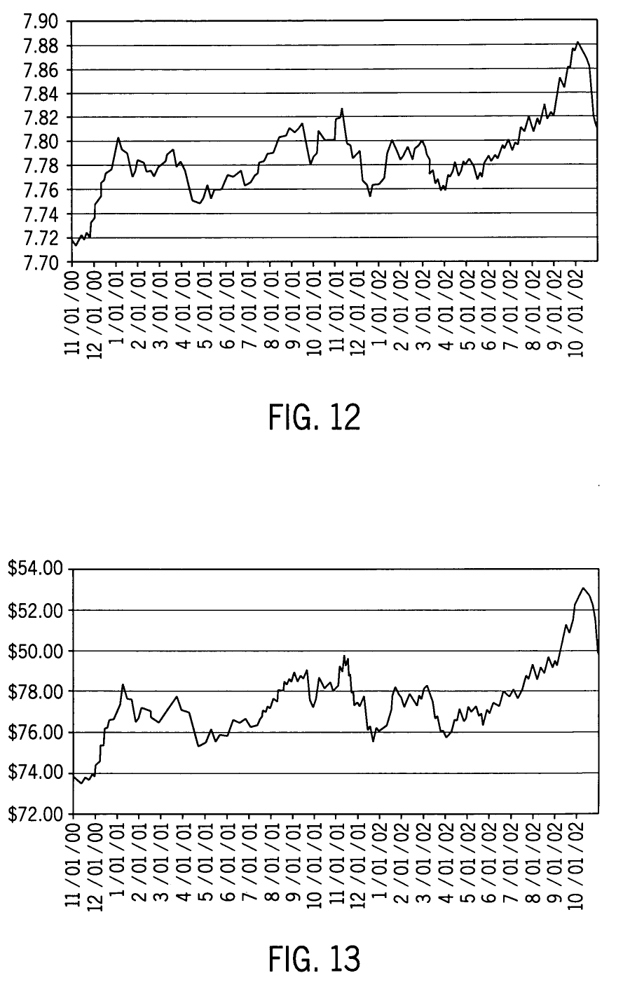

Municipal note futures contract of the present invention provide superior tools for targeting the duration of tax-exempt portfolios in keeping with anticipated interest rate developments. When forecasts call for lower interest rates, managers often lengthen duration to maximize returns. When forecasts call for higher interest rates, managers can shorten duration to maintain their performance edges during these adverse periods. FIG. 12 illustrates the duration history of the example municipal note futures contract of the present invention.

Using futures to retarget portfolio duration offers numerous advantages over other tactical choices. Futures users can preserve the integrity of a carefully designed portfolio. A futures position is easily and quickly reversible in case the interest rate forecasts prove wrong. And futures are superior to other duration adjustment tools in terms of cost-effectiveness.

### Example of Use of the Present Invention—Reducing Cash Drag

Portfolio managers can also use municipal note futures contracts of the present invention to structure synthetic exposure to this sector and so put excess cash to work. Tax-exempt portfolios, like any other fixed-income holdings, generate large amounts of cash from coupon payments and called or maturing bonds. Large cash holdings, having no yield, can undermine performance. Yet it is not always possible to locate the securities needed to maintain the desired portfolio structure.

Facing this dilemma, tax-exempt managers can use municipal note futures contract of the present invention to securitize cash quickly and for low cost. An appropriately sized municipal note futures contract of the present invention positioned in conjunction with a money market investment can earn total returns roughly equivalent to those of the underlying portfolio. As appropriate securities become available, managers can replace part of the futures money market position with actual security positions.

### Example of Use of the Present Invention—The MUT Spread

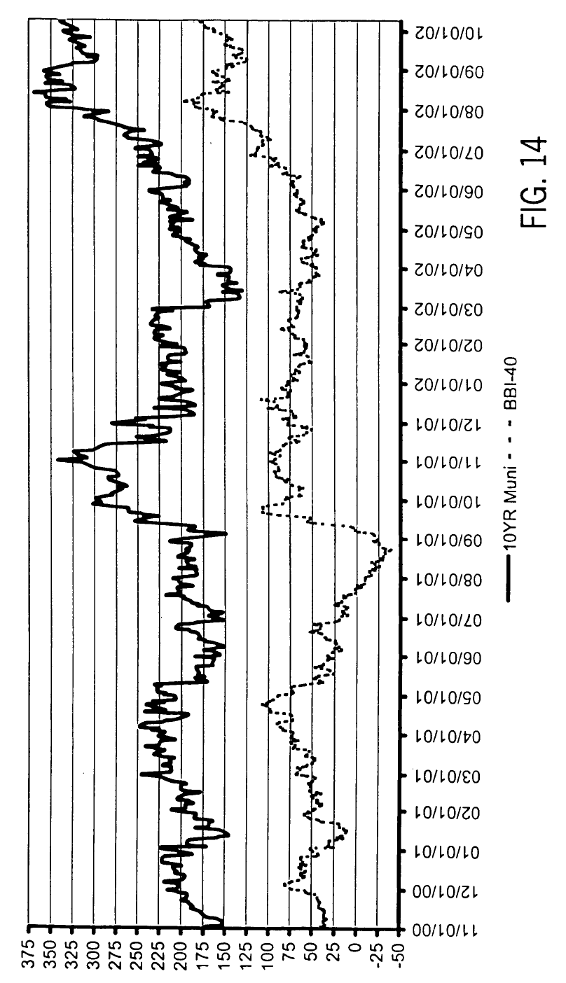

An intermarket spread entails a long position in one commodity, and a short position in another similar but different commodity. FIG. 13 plots the DV01 s of the shows the example municipal note futures contract that traders could have used to structure such intermarket spread positions. The MUT spread (municipals under tens) is the difference in price between the municipal futures contract and the 10 year Treasury note futures contract. The MUT spread provides traders with a way to capitalize on periods when either the tax-exempt or the 10 year Treasury note sector seems poised to outperform the other, regardless of the ultimate movement of price either up or down. During periods of heavy tax-exempt issuance, market users can usually expect to see price drops among tax-exempt securities. At such times, this fixed-income sector is likely to under perform the 10-year Treasury note sector. Conversely, when the Treasury must meet greater than normal funding needs, relatively heavier issuance of Treasury notes can drive the performance imbalance in favor of municipal bonds. Utilization of the municipal note futures contracts of the present invention as the “municipal” in MUT provides an improved tracking of the municipal bond sector against the 10-year Treasury note sector.

Anticipating strong municipal issuance, for example, traders can go short municipal note futures contract of the present invention and long 10 year Treasury note futures to capitalize on the expected out performance by the 10 year Treasury sector Of course, a duration weighted spread (equivalently, DV01-weighted) will isolate the relative performance factor and filter extraneous directional interest rate effects out of the trade. FIG. 14 shows the example contract in accordance with the principals of the present invention vs. the CBOT 10-year U.S. Treasury Note Futures (MUT Spread) for Nov. 1, 2000-Oct. 8, 2002.

### Example of Use of the Present Invention—The MUF Spread

The MUF spread (municipals under futures) is the difference in price between the municipal futures contract and the 5 year Treasury note futures contract. The MUF spread provides traders with a way to capitalize on periods when either the tax-exempt or the 5 year Treasury note sector seems poised to outperform the other, regardless of the ultimate movement of price either up or down. During periods of heavy tax-exempt issuance, market users can usually expect to see price drops among tax-exempt securities. At such times, this fixed-income sector is likely to under perform the 5-year Treasury note sector. Conversely, when the Treasury must meet greater than normal funding needs, relatively heavier issuance of Treasuries can drive the performance imbalance in favor of municipal bonds. Utilization of the municipal note futures contracts of the present invention as the “municipal” in MUF provides an improved tracking of the municipal bond sector against the 5-year Treasury note sector.

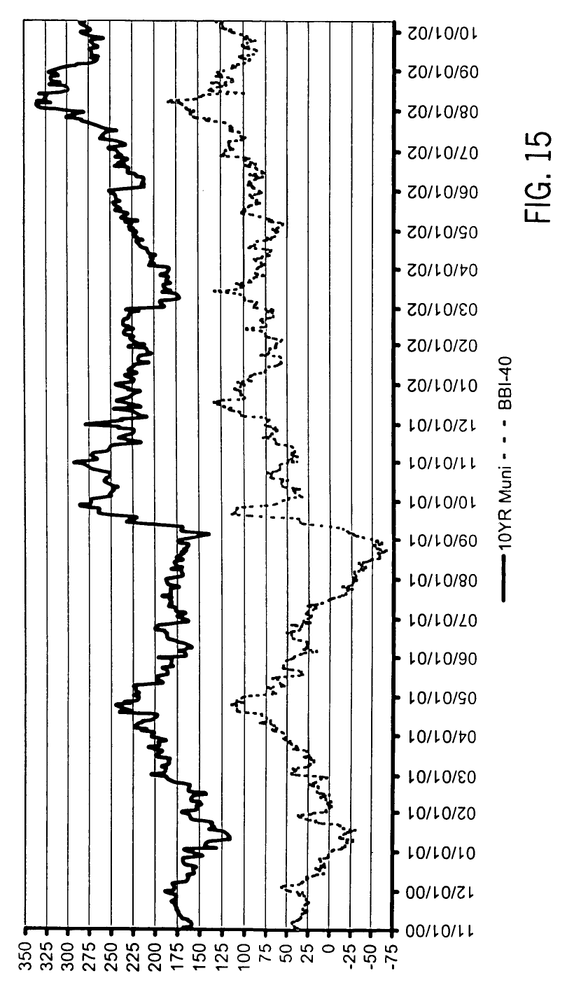

Anticipating strong municipal issuance, for example, traders can go short municipal note futures contract of the present invention and long 5 year Treasury note futures to capitalize on the expected out performance by the Treasury sector Of course, a duration weighted spread (equivalently, DV01-weighted) will isolate the relative performance factor and filter extraneous directional interest rate effects out of the trade. FIG. 15 shows the example contract in accordance with the principals of the present invention vs. the CBOT 5-year U.S. Treasury Note Futures (MUF Spread) for Nov. 1, 2000-Oct. 8, 2002. Of course, Treasury note futures of other than 5-year and 10-year duration could be utilized.

### Example of Use of the Present Invention—The MOB Spread

The MOB (municipals over bonds) spread is the difference in price between the municipal bond futures contract and the Treasury bond futures contract. The MOB spread provides traders with a way to capitalize on periods when either the tax-exempt or the Treasury bond sector seems poised to outperform the other, regardless of the ultimate movement of price either up or down. During periods of heavy tax-exempt issuance, market users can usually expect to see price drops among tax-exempt securities. At such times, this fixed-income sector is likely to under perform the Treasury bond sector. Conversely, when the Treasury must meet greater than normal funding needs, relatively heavier issuance of Treasuries can drive the performance imbalance in favor of municipal bonds. Utilization of the municipal note futures contracts of the present invention as the “municipal” in MOB provides an improved tracking of the municipal bond sector against the Treasury bond sector.

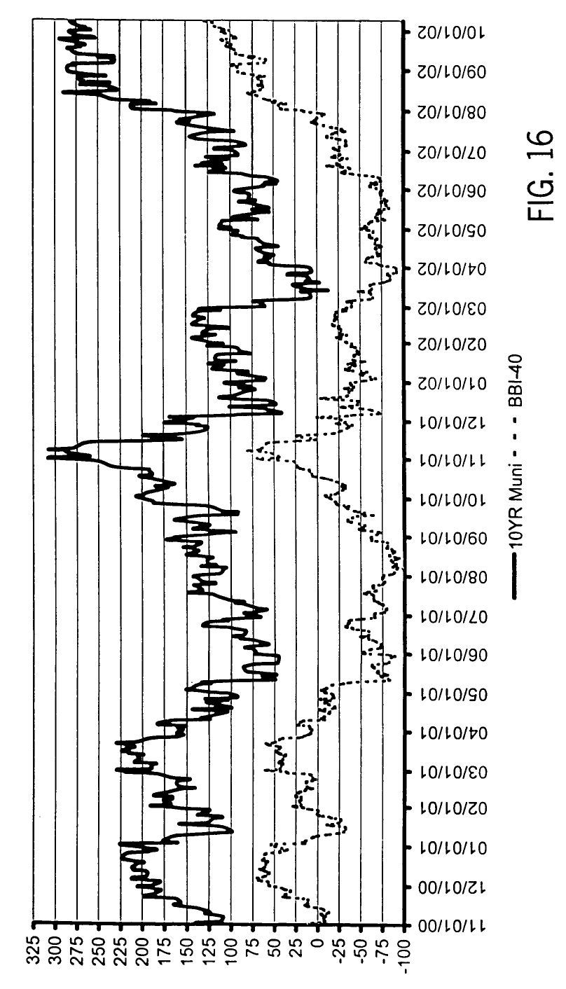

Anticipating strong municipal issuance, for example, traders can go short municipal note futures contract of the present invention and long Treasury bond futures to capitalize on the expected out performance by the Treasury sector Of course, a duration weighted spread (equivalently, DV01-weighted) will isolate the relative performance factor and filter extraneous directional interest rate effects out of the trade. FIG. 16 shows the example contract in accordance with the principals of the present invention vs. the CBOT U.S. Treasury Bond Futures (MOB Spread) for Nov. 1, 2000-Oct. 8, 2002.

### Example of Use of the Present Invention—The SAM Spread

The SAM (swaps against municipals) spread is the difference in price between the 10-year swap futures contract and the municipal bond futures contract. The SAM spread provides traders with a way to capitalize on periods when either the swap futures contract or the tax-exempt sector seems poised to outperform the other, regardless of the ultimate movement of price either up or down. During periods of heavy tax-exempt issuance, market users can usually expect to see price drops among tax-exempt securities. At such times, this fixed-income sector is likely to under perform the swap futures contract. In addition, credit deterioration in swaps market could lead municipal bonds to outperform swaps. Utilization of the municipal note futures contracts of the present invention as the “municipal” in SAM provides an improved tracking of the municipal bond sector against the swap futures contract.

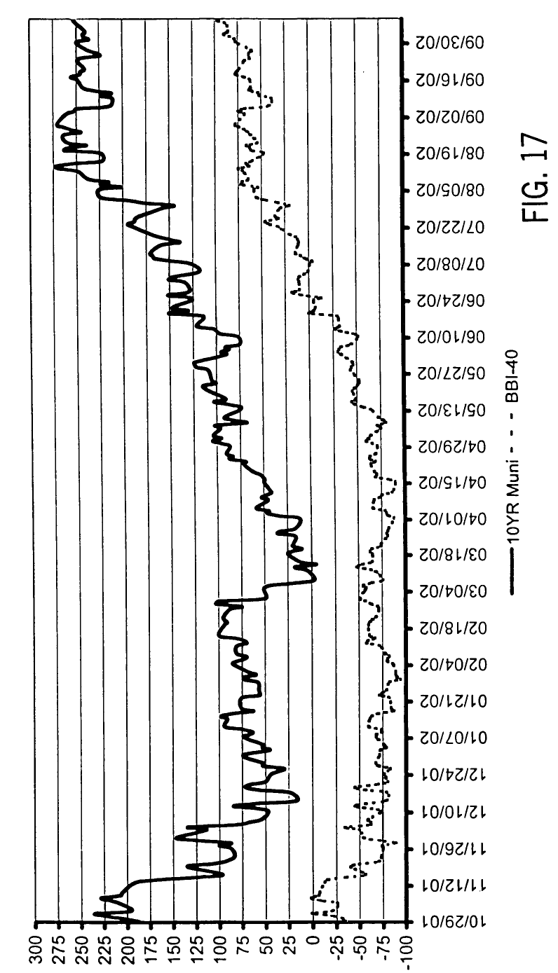

Anticipating strong municipal issuance, for example, traders can go short municipal note futures contract of the present invention and long swap futures contract to capitalize on the expected out performance by the swap futures contract. A duration weighted spread (equivalently, DV01-weighted) will isolate the relative performance factor and filter extraneous directional interest rate effects out of the trade. FIG. 17 shows the example contract in accordance with the principals of the present invention vs. the CBOT U.S. Municipal Futures (SAM Spread) for Nov. 1, 2000-Oct. 8, 2002. Of course, swap futures contracts of other than 10-year duration could be utilized.

### Example of use of the Present Invention—The MAG Spread

The MAG (municipals against agency) spread is the difference in price between the municipal bond futures contract and the 10-Year U.S. Agency Note futures contract. The MAG spread provides traders with a way to capitalize on periods when either the tax-exempt or the U.S. Agency Note futures contract seems poised to outperform the other, regardless of the ultimate movement of price either up or down. During periods of heavy tax-exempt issuance, market users can usually expect to see price drops among tax-exempt securities. At such times, this fixed-income sector is likely to under perform the 10-Year U.S. Agency Note futures contract. Conversely, when the Federal National Mortgage Association (Fannie Mae), 3900 Wisconsin Avenue, NW, Washington, D.C. 20016-2892 or the Federal Home Loan Mortgage Corporation (Freddie Mac), 401 9th Street, NW, Suite 600 South, Washington, D.C. 20004 must meet greater than normal funding needs, relatively heavier issuance of agencies can drive the performance imbalance in favor of municipal bonds. Utilization of the municipal note futures contracts of the present invention as the “municipal” in MAG provides an improved tracking of the municipal bond sector against the 10-year U.S. Agency Note futures contract.

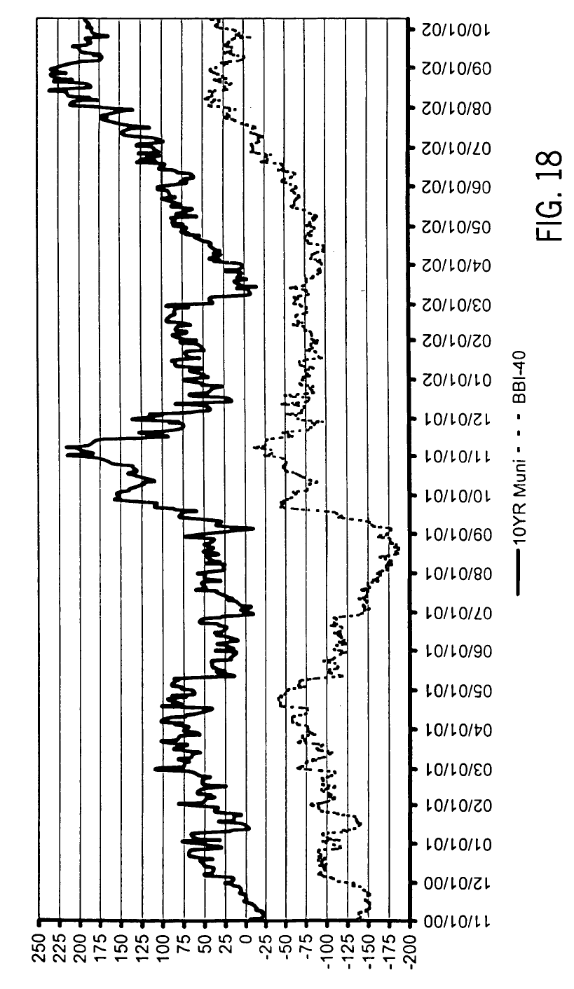

Anticipating strong municipal issuance, for example, traders can go short municipal note futures contract of the present invention and long the 10-year U.S. Agency Note futures contract to capitalize on the expected out performance by the 10-year U.S. Agency Note futures contract. Of course, a duration weighted spread (equivalently, DV01-weighted) will isolate the relative performance factor and filter extraneous directional interest rate effects out of the trade. FIG. 18 shows the example contract in accordance with the principals of the present invention vs. the CBOT 10-Year U.S. Agency Note futures (MAG Spread) for Nov. 1, 2000-Oct. 8, 2002. Of course, Agency Note futures of other than 10-year duration could be utilized.

While the invention has been described with specific embodiments, other alternatives, modifications and variations will be apparent to those skilled in the art. Accordingly, it is intended to include all such alternatives, modifications and variations set forth within the spirit and scope of the appended claims.

What is claimed is:

1 A municipal note futures contract comprising:
an underlying index of municipal bonds;
price transparency for market users;
progress toward standardization of an underlying market; and
diminution of manpower and financial search and record keeping costs that alternative modes of risk management entail.

2 The municipal note futures contract of claim 1 further including a par-trading unit.

3 The municipal note futures contract of claim 2 further wherein the par-trading unit is about $100,000.

4 The municipal note futures contract of claim 1 further including pricing in points.

5 The municipal note futures contract of claim 4 further wherein the pricing point is about $1,000 and the contract has about one thirty-second of one point tick size.

6 The municipal note futures contract of claim 1 further wherein the contract trades on the March, June, September, December cycle.

7 The municipal note futures contract of claim 1 further wherein the municipal note futures contract is used to design hedges.

8 The municipal note futures contract of claim 1 further wherein the municipal note futures contract is used to expand or reduce exposure to a sector.

9 The municipal note futures contract of claim 1 further wherein the municipal note futures contract is used to create coverage in anticipation of a shift into a sector.

10 The municipal note futures contract of claim 1 further wherein the municipal note futures contract is used to generate a synthetic position.

11 The municipal note futures contract of claim 1 further wherein the municipal note futures contract is used to retarget portfolio duration.

12 The municipal note futures contract of claim 1 further wherein the municipal note futures contract is used to securitize cash.

13 The municipal note futures contract of claim 1 further wherein the municipal note futures contract is used as the municipal future in a municipal under future intermarket spread.

14 The municipal note futures contract of claim 13 further wherein the municipal note futures contract is used as the municipal future in a municipal under 5-year Treasury note future intermarket spread.

15 The municipal note futures contract of claim 13 further wherein the municipal note futures contract is used as the municipal future in a municipal under 10-year Treasury note future intermarket spread.

16 The municipal note futures contract of claim 1 further wherein the municipal note futures contract is used as the municipal future in a municipal over Treasury bond future intermarket spread.

17 The municipal note futures contract of claim 1 further wherein the municipal note futures contract is used as the municipal future in a swap against municipal intermarket spread.

18 The municipal note futures contract of claim 1 further wherein the municipal note futures contract is used as the municipal future in a 10-year swap against municipal intermarket spread.

19 The municipal note futures contract of claim 1 further wherein the municipal note futures contract is used as the municipal future in a municipal against agency intermarket spread.

20 The municipal note futures contract of claim 1 further wherein the municipal note futures contract is used as the municipal future in a municipal against 10-year agency intermarket spread.

21 A municipal note index comprising:
an underlying index of municipal bonds, the municipal bonds being a sufficient number to maintain a broad reflection of the market as a whole, the municipal bonds being chosen to represent a widely dispersed sampling, and the municipal bonds being issued by an issuer who has a minimal credit rating depending on a target sector;
each municipal bond being of a minimal principal size, and each municipal bond being apart of a minimal offering size;
each municipal bond having a minimum value at its issuance date;
any municipal bonds that have had outsized price moves on settlement date are eliminated; and
the underlying index of municipal bonds being revised frequently enough to prevent the underlying index of municipal bonds from becoming stale while minimizing disruptions.

22 The municipal note index of claim 21 further wherein municipal bonds issued as private placements are not eligible for inclusion in the index.

23 The municipal note index of claim 21 further wherein the number of municipal bonds is about 100 to about 250 municipal bonds

24 The municipal note index of claim 21 further wherein the number of municipal bonds is 247.

25 The municipal note index of claim 21 further wherein the municipal bonds are generally exempt from federal income taxation.

26 The municipal note index of claim 25 further wherein the municipal bonds include generally exempt bonds whose interest payments may be subject to an alternative minimum tax.

27 The municipal note index of claim 21 wherein for the index to be a representative sample of market values in a high-grade sector of the tax-exempt bond market, the issuer has at least an AAA credit rating.

28 The municipal note index of claim 21 further wherein if any municipal bonds in the index become ineligible during the life of the index, that bond will be eliminated from the index.

29 The municipal note index of claim 28 further wherein if any municipal bonds in the index suffer a downgrade to below a minimal credit rating during the life of the index, that bond will be eliminated from the index.

30 The municipal note index of claim 29 further wherein for the index to be a representative sample of market values in the high-grade sector of the tax-exempt bond market, if any bonds in the index suffer a downgrade to a credit rating below A− or A3, such bond will be eliminated from the index.

31 The municipal note index of claim 21 further wherein each bond has a principal size of at least about $50 million and is a part of a municipal issue with a total deal size of at least about $200 million.

32 The municipal note index of claim 31 further wherein the average principal amount of the included bonds was over about $105 million and the bonds are parts of larger deals with average issue sizes in excess of about $569 million.

33 The municipal note index of claim 21 further wherein each municipal bond has a remaining maturity within a range between 10 and 40 years from the first calendar day of the corresponding futures contract expiration.

34 The municipal note index of claim 21 further wherein eligible bonds can be callable or non-callable.

35 The municipal note index of claim 34 further wherein if callable, the bond has a first call date a sufficient time distance in the future.

36 The municipal note index of claim 35 further wherein the bond has a first call date at least 7 years from the first calendar day of the corresponding futures contract expiration.

37 The municipal note index of claim 21 further wherein the bond must be at least a minimal price at its issuance date.

38 The municipal note index of claim 37 further wherein the issue price of the bond must be at least 90-00 at its issuance date.

39 The municipal note index of claim 21 further wherein the bond must pay semi-annual interest at a fixed coupon rate that ranges from about three percent (3%) to about nine percent (9%).

40 The municipal note index of claim 21 further wherein no more than a maximum number of the bonds in the index are from any one issuer.

41 The municipal note index of claim 40 further wherein no more than about five percent (5%) of the bonds in the index are from any one issuer.

42 The municipal note index of claim 21 further wherein no more than a maximum number of the bonds in the index are from any one state or territory.

43 The municipal note index of claim 42 further wherein no more than fifteen percent (15%) of the bonds in the index are from any one state or territory.

44 The municipal note index of claim 21 further wherein the bonds in the index may or may not be insured.

45 The municipal note index of claim 44 further wherein if the index includes insured bonds, no more than forty percent (40%) are insured by any one issuer.

46 The municipal note index of claim 21 further wherein the composition of the index is revised sufficiently to ensure that it remains an accurate gauge of the municipal bond market.

47 The municipal note index of claim 46 further wherein the composition of the index is revised once each quarter.

48 The municipal note index of claim 21 further wherein any bond whose price change from the previous day is more than one standard deviation of the average price change of all the component bonds will be excluded from the index for determination of a settlement price.

49 The municipal note index of claim 21 further wherein if more than the maximum number bonds meet the eligibility requirements at an index revision time, the issue size standard is increased until it arrives at a level where no more than the maximum bonds remain eligible for inclusion.

50 The municipal note index of claim 21 further wherein on the last day of trading, open contracts will be marked to market based on the closing futures prices.

51 The municipal note index of claim 50 further wherein a final mark to market will be made on the day the contract expiration price is determined.

52 A method of calculating a municipal note index value comprising:
pricing the index at a time interval;
utilizing an independent evaluation pricing service to evaluate prices for individual component bonds and compute a closing value of the index; and
calculating the final settlement value utilizing the simple average yield-to-worst of the component bonds in the index for the last day of trading;
such that the index is efficient, transparent, and enhances the fair market value determination of the index.

53 The method of calculating a municipal note index value of claim 52 further wherein in the index is priced once daily.

54 The method of calculating a municipal note index value of claim 52 further wherein the index is priced by an independent evaluation pricing service.

55 The method of calculating a municipal note index value of claim 54 further wherein the index is priced by a single independent evaluation pricing service.

56 The method of calculating a municipal note index value of claim 52 further wherein the index is cash settled on the last day of trading based on an independent evaluation pricing service determination of the underlying index value.

57 The method of calculating a municipal note index value of claim 52 further wherein the final settlement value (FSV) of the futures contract is calculated according to the following:
FSV=$100,000*[5/r+(1-5/r)*(1+r/200)−20];
where r represents the simple average yield-to-worst of the component bonds in the index for the last day of trading.

58 The method of calculating a municipal note index value of claim 57 further wherein the simple average yield-to-worst of the component bonds in the index for the last day of trading is expressed in percent terms and calculated to the nearest 1/10 of a basis point.

59 The method of calculating a municipal note index value of claim 58 further wherein the contract expiration price is the final settlement value rounded to the nearest one thirty-second of one point.
